(19) United States
(12) Patent Application Publication
(10) Pub. No.: US 2008/0263577 A1
(43) Pub. Date: Oct. 23, 2008

(54) Disc cartridge

(75) Inventor: Atsushi Sato, Ibaraki (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/905,272

(22) Filed: Sep. 28, 2007

(30) Foreign Application Priority Data
Feb. 23, 2007 (JP) 2007-044103

(51) Int. Cl. G11B 23/03

(52) U.S. Cl. 720/728

(57) ABSTRACT

The invention provides a structure of a disc cartridge which can correspond to a two-head system while keeping an advantage relating to a light shielding effect and a dust proofing effect of a double cartridge. The invention provides a disc cartridge used in a hologram information recording and reproducing apparatus independently provided with a head for detecting a tracking area and a head for recording and reproducing, in which the disc cartridge is provided with an outer cartridge, an inner cartridge accommodated in an inner side of the outer cartridge and rotatably accommodating a hologram recording medium in an inner portion thereof, and a shutter arranged between the outer cartridge and the inner cartridge and provided for opening and closing an opening portion of the disc cartridge. Further, the opening portion includes a recording and reproducing head and spindle insertion hole, and a tracking area detecting window provided independently therefrom. Further, the tracking area detecting window is provided near a center of the cartridge in the spindle insertion hole, and comes to an exposed state only at a time when the shutter is open. Preferably, the tracking area detecting window is provided at an angle between 40 to 50 degree from a center line of the recording and reproducing head and spindle insertion hole.

### BACKGROUND OF THE INVENTION

1. Field of the Invention

The present invention relates to a structure of a disc cartridge for rotatably accommodating an information recording medium such as an optical disc or the like so as to record and reproduce, and particularly to a structure of a disc cartridge which is preferable for a hologram recording and reproducing.

2. Description of Related Art

A digital hologram recording is a method of recording an interference point in a thickness direction of a recording layer by utilizing an interference of a recording beam and a reference beam, and reading an information recorded at the interference point by the reference beam, as is different from the conventional optical disc, and can record and reproduce a large-capacity and high-speed information in cooperation with a point that a large amount of data can be recorded by one light irradiation.

A conventional recording medium used for the hologram recording is mainly constituted by an inorganic single crystal called as a photorefractive crystal such as a lithium niobate single crystal, and has a problem that it is expensive and hard to be worked. On the contrary, an organic hologram material based on a light-cured type material is expected a dramatic improvement with respect to the problem mentioned above, and has been carried out investigation in recent years. The organic type hologram recording material employs a material obtained by mixing and dispersing the light-cured type material corresponding to the recording material into a high polymer matrix forming a support medium thereof. There is employed a method of diluting the material in a solvent so as to form a coating material and apply on a substrate, or working the material in a film shape so as to apply to a base material, for forming the recording medium.

Since the recording is executed by a recording beam such as a laser beam in the hologram recording, it is important how the material is shielded from the light so as to be stored in an unrecorded state until the recording is executed. For example, patent document 1 (JP-A-2005-243118) discloses a cartridge for a hologram disc which is constituted by a double structure of an inner cartridge and an outer cartridge and has a light shielding effect and a dust proofing effect. Further, in the case of recording and reproducing the information on the hologram recording medium accommodated in the cartridge, a recording and reproducing operation is achieved by opening a shutter so as to partly expose the hologram recording medium and irradiating the light from the recording and reproducing head to the recording medium.

In this case, it is necessary to execute a tracking servo at a time of the recording and reproducing operation, however, the tracking servo has a case of using a recording and reproducing head (one-head system), and a case that a head for a tracking servo is provided in addition to the recording and reproducing head (two-head system).

However, if the two-head system is applied to the cartridge described in the patent document 1, there is a possibility that the head for the tracking servo and the recording and reproducing head are interfered with each other in the case of recording the information to a limit of an innermost circumferential portion in a recording region of the recording medium and reproducing the information recorded there.

Accordingly, it is desirable to arrange the head for the tracking servo in such a place that no influence is applied to a movable range of the recording and reproducing head, and there can be considered to secure an opening portion by a shutter large, as one achievable idea.

However, if the opening portion is secured large, the light shielding effect and the dust proofing effect are affected inversely.

### BRIEF SUMMARY OF THE INVENTION

The present invention is made by taking the circumstance mentioned above into consideration, and an object of the present invention is to provide a structure of a disc cartridge which can correspond to a two-head system while keeping an advantage relating to a light shielding effect and a dust proofing effect of a double cartridge.

In order to solve the problem mentioned above, in accordance with the present invention, there is provided a disc cartridge used in a hologram information recording and reproducing apparatus independently provided with a head for detecting a tracking area and a head for recording and reproducing, in which the disc cartridge is provided with an outer cartridge, an inner cartridge accommodated in an inner side of the outer cartridge and rotatably accommodating a hologram recording medium in an inner portion thereof, and a shutter arranged between the outer cartridge and the inner cartridge and provided for opening and closing an opening portion of the disc cartridge. Further, the opening portion includes a recording and reproducing head and spindle insertion hole, and a tracking area detecting window provided independently therefrom. Further, the tracking area detecting window is provided near a center of the cartridge in the spindle insertion hole, and comes to an exposed state only at a time when the shutter is open. Preferably, the tracking area detecting window is provided at an angle between 40 to 50 degree from a center line of the recording and reproducing head and spindle insertion hole.

Further, it is desirable that the tracking area detecting window is provided in a surface with which the spindle of the disc drive is brought into contact, in the disc cartridge, and is formed in a larger circular shape than a diameter of the laser beam for the tracking servo.

Further, the tracking area detecting window is provided near the spindle insertion hole in a sliding direction side of the shutter, and the shutter is provided with a notch in an edge portion in an opposite side to the sliding direction side. On the basis of the notch, the tracking area detecting window comes to the exposed state at a time when the shutter is fully open. In other words, if the notch is not provided, the tracking detecting window does not come to the completely exposed state.

The further features of the present invention will be apparent from the following best mode for carrying out the present invention and the accompanying drawings.

In accordance with the present invention, even in the two-head system independently provided with the recording and reproducing head and the head for the tracking servo, it is possible to record and reproduce the information to the limit of the innermost circumference of the recording region without interference of two heads, and it is possible to provide the disc cartridge which is excellent in the light shielding effect and the dust proofing effect.

### BRIEF DESCRIPTION OF THE SEVERAL VIEWS OF THE DRAWINGS

FIG. 1 is an exploded perspective view of a disc cartridge in accordance with an embodiment of the present invention;

FIG. 2 is a front elevational view of the disc cartridge in accordance with the embodiment of the present invention;

FIG. 3 is a back elevational view of the disc cartridge in accordance with the embodiment of the present invention;

FIG. 4 is a view showing a state (a state in which a shutter is closed) in the case that an outer lower half is taken off from the disc cartridge, and an inner lower half 5b and a shutter 4 are exposed;

FIG. 5 is a view showing a state (a state in which the shutter is open) in the case that the outer lower half is taken off from the disc cartridge, and the inner lower half 5b and the shutter 4 are exposed;

FIG. 6 is a view showing a shutter closed state of the disc cartridge in accordance with the embodiment of the present invention;

FIG. 7 is a view showing a shutter open state of the disc cartridge in accordance with the embodiment of the present invention;

FIG. 8 is a view showing a shutter full open state of the disc cartridge in accordance with the embodiment of the present invention;

FIG. 9 is a view showing a state at a time of closing the shutter in the case of a forward direction insertion of an erroneous insertion preventing function in accordance with an embodiment of the present invention;

FIG. 10 is a view showing a state at a time of fully opening the shutter in the case of the forward direction insertion of the erroneous insertion preventing function in accordance with the embodiment of the present invention;

FIG. 11 is a view showing a state at a time of a backward direction insertion of the erroneous insertion preventing function in accordance with the embodiment of the present invention;

FIG. 12 is an enlarged view showing a step portion of an inner cartridge and an outer cartridge in accordance with an embodiment of the present invention; and

FIG. 13 is a view showing a lock mechanism of the shutter used in the cartridge in accordance with the embodiment of the present invention.

### DETAILED DESCRIPTION OF THE INVENTION

A description will be given below of an embodiment in accordance with the present invention with reference to the accompanying drawings. In this case, it should be taken account that the present embodiment is only one example for achieving the present invention, and does not limit the present invention. Further, the same reference numerals are attached to the common structures in each of the drawings.

### <Structure of Disc Cartridge>

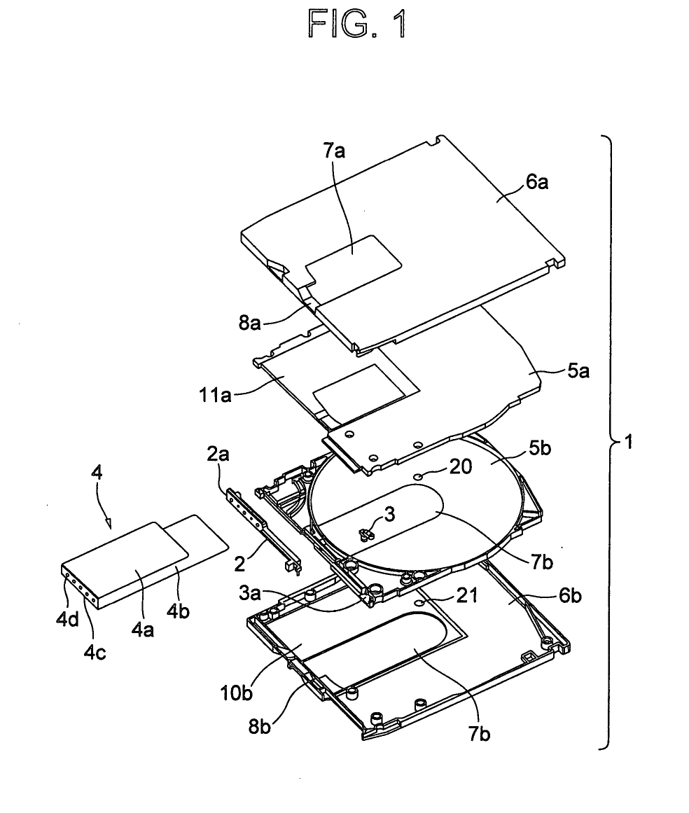

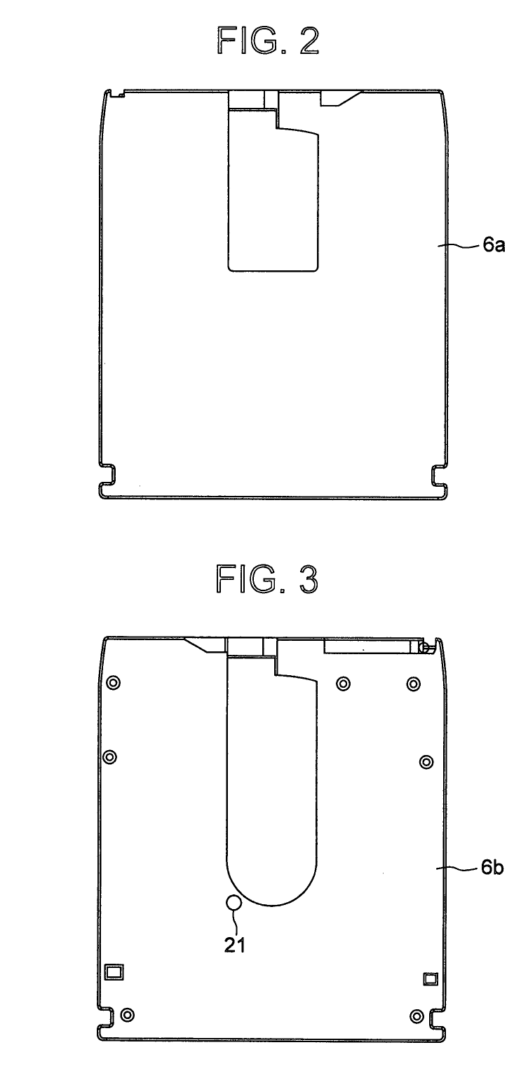

FIG. 1 is an exploded perspective view of a disc cartridge in accordance with the present embodiment, FIG. 2 is a front elevational view of the disc cartridge, and FIG. 3 is a back elevational view of the disc cartridge.

The disc cartridge in accordance with the embodiment of the present invention is mainly constituted by a cartridge case 1, a slider 2, a lock member 3 and a shutter 4.

The cartridge case 1 is formed as a double case structure having an inner cartridge 5 constituted by an inner upper half 5a and an inner lower half 5b, and an outer cartridge 6 constituted by an outer upper half 6a and an outer lower half 6b which are arranged in an outer side in a thickness direction of the inner cartridge 5.

In the outer upper half 6a, an outer upper head insertion hole 7a is formed approximately in the center of a front side as shown in FIGS. 1 and 2, and in the outer lower half 6b, an outer lower head and spindle insertion hole 7b is formed approximately in the center of a front side as shown in FIGS. 1 and 3, respectively.

Further, as shown in FIG. 1, an inner surface of the outer lower half 6b is provided with a lower concave portion 10b which is further lower at a width including the outer lower head and spindle insertion hole 7b in an inner side, and a lower concave portion 10a (not shown) is provided in an inner surface of the outer upper half 6a in the manner. Upper concave portions 11a and 11b are provided in the inner upper half 5a and the lower half 5b as shown in FIG. 1 in such a manner as to approximately correspond to outer shapes of the lower concave portions 10a and 10b. A gap along which upper and lower flat plate portions 4a and 4b of the shutter 4 slide is formed between the inner upper half 5a and the outer upper half 6a and between the inner lower half 5b and the outer lower half 6b by the lower concave portions 10a and 10b and the upper concave portions 11a and 11b, and a sliding range of the shutter 4 is regulated.

Further, the inner lower half 5b is provided with a tracking area detecting window 20 for irradiating a laser beam for a tracking servo onto an accommodated hologram recording medium. Further, the outer lower half 6b is provided with a tracking area detecting window 21 at a position opposing to the tracking area detecting window 20 of the inner lower half 5b.

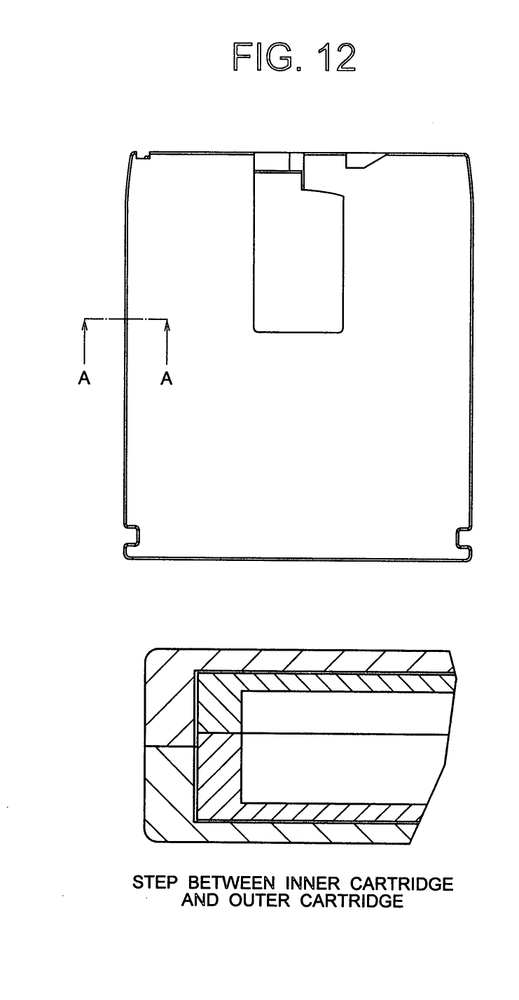

Each of the outer upper half 6a and the outer lower half 6b is structured at the same thickness, but a ratio of thicknesses of the inner upper half 5a and the inner lower half 5b is differentiated. In accordance with the structure mentioned above, it is possible to obtain a structure increasing a light shielding effect and a dust proofing effect, by setting a step in the inner cartridge and the outer cartridge as shown in FIG. 12.

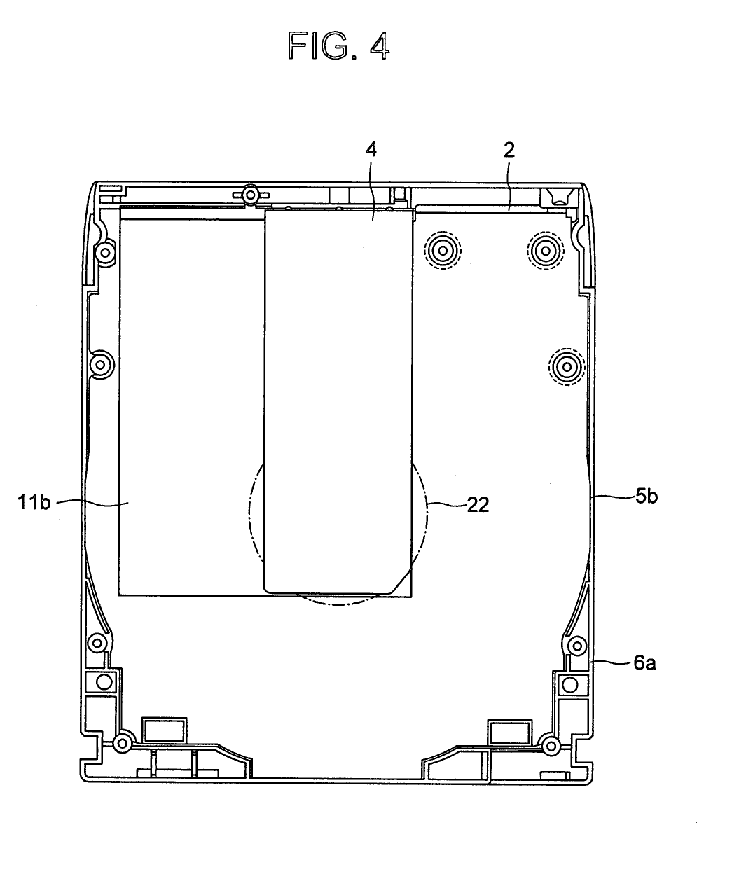

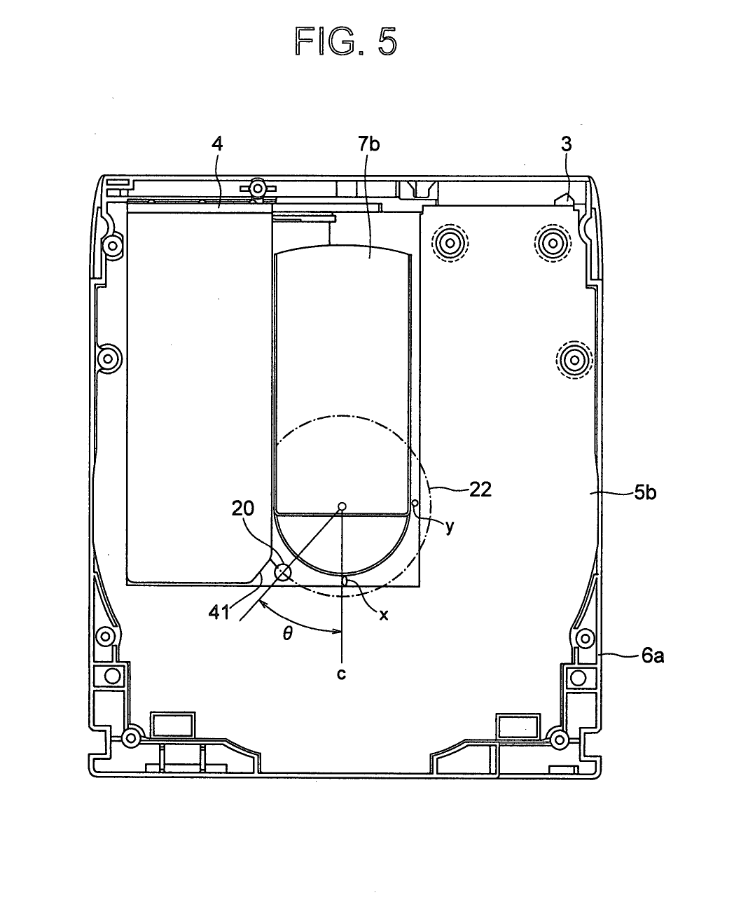

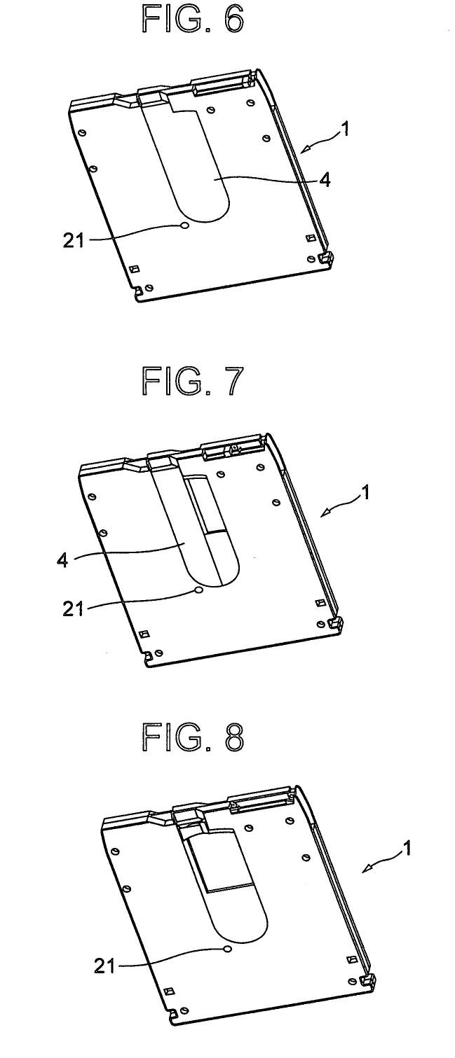

FIGS. 4 and 5 are views showing a state in which the outer lower half 6b is detached from the cartridge case 1, and the inner lower half 5b and the shutter 4 are exposed. FIGS. 4 and 5 well express the feature of the present invention. When the shutter 4 is closed (refer to FIG. 4), the tracking area detecting window 20 is concealed by the shutter. Accordingly, when the disc cartridge is not installed to the drive, the shutter 4 shields the light and the dust, and prevents the accommodated hologram recording medium from being exposed to light or damaged by the dust. Further, as shown in FIG. 5, when the shutter 4 is open, the tracking area detecting window 20 appears in and near the spindle insertion hole 7b provided in the inner lower half 5b. The tracking area detecting window 20 is structured such as to be positioned approximately just above a tracking area 22 (only its position is shown in the drawing because the hologram recording medium is not accommodated) of the accommodated hologram recording medium. Further, if the tracking area detecting window 20 is arranged at a position which is at θ degree from a center line C of the opening portion in a clockwise direction, the tracking area detecting window 20 can be achieved without changing magnitudes of the current shutter and opening portion. If sizes x and y of an overlapping portion between the shutter 4 and the inner lower half 5b are identical, the angle θ comes to 45 degree. In this case, the angle θ is 41 degree at a time when the sizes x and y have a relation shown in FIG. 5, however, the angle θ may be approximately within a range 40 degree≦θ≦50 degree. Further, in order to secure a space of the tracking area detecting window 20, a notch portion 41 is provided in the shutter 4.

As mentioned above, it is possible to provide the disc cartridge which can also correspond to the two-head system while keeping the opening portion of the cartridge case 1 minimum, by concealing the tracking area detecting window 20 by the shutter 4 at a time when the shutter 4 is closed, and exposing the tracking area detecting window 20 only at a time when the shutter 4 is open. In this case, the tracking area detecting window 20 may be provided at a position which is at the angle θ from the center line C in a counterclockwise direction. At this time, the notch portion 41 is not necessary in the shutter 4. In this case, it is more convenient for light shielding the hologram recording medium and proofing the dust in the case that the tracking area detecting window 20 is provided at the position at the angle θ in the clockwise direction.

### <Attachment of Slider and Shutter>

The shutter 4 is constituted by upper and lower flat plate portions 4a and 4b and a coupling portion 4c. The shutter 4 is combined with the slider 2, and slides along slider rails A provided in the inner upper half 5a and slide rails B provided in the inner lower half 5b.

The shutter 4 is position regulated in a lateral direction with respect to a front surface direction shown in FIG. 2 by a slider positioning projection 2a provided in the slider 2, and a hole 4d for fitting the projection 2a provided in the coupling portion 4c of the shutter 4. Further, a position in an upward direction with respect to the front surface direction shown in FIG. 2 is regulated by the outer cartridge 6.

The coupling portion 4c of the shutter 4 is covered by bridges 8a and 8b forming end portions of the outer upper head insertion hole 7a and the outer lower head and spindle insertion hole 7b provided in the outer upper half 6a and the outer lower half 6b, and is hardly provided with an exposing portion. Further, the structure is made such as to slide between the inner cartridge 5 and the outer cartridge 6, whereby a whole of the shutter is not exposed to the front surface, at a time when the shutter is in an open state. It is possible to prevent the shutter from being carelessly opened, by employing the structure mentioned above.

### <Lock Mechanism>

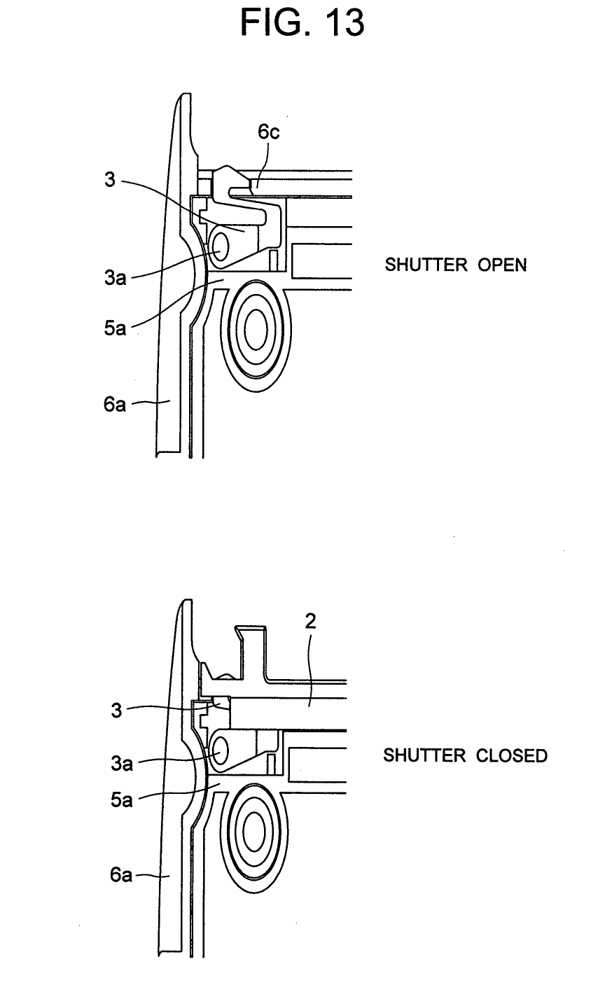

FIG. 13 is a view showing a lock mechanism of the shutter 4. The double cartridge is provided with the lock member 3, the inner cartridge 5 and the outer cartridge 6 engaging with the slider 2. Further, the structure is made such that the slider 2 in which the shutter 4 is assembled is locked at a full close position for making the shutter 4 and the shutter 4 slidable. A center of rotation of the lock member 3 is provided within the inner cartridge 5, and a regulating portion of the lock member 3 is provided in the outer cartridge 6. Accordingly, a careless fitting step between the inner cartridge 5 and the outer cartridge 6 is not generated on a surface on which the slider 2 slides for opening and closing the shutter 4. Further, since it is not necessary to consider an interference with the slide caused by the fitting step between the inner cartridge 5 and the outer cartridge 6 in the slider 2, it is possible to freely design in correspondence to a shape and an intended use of the slider.

### <Erroneous Insertion Preventing Mechanism>

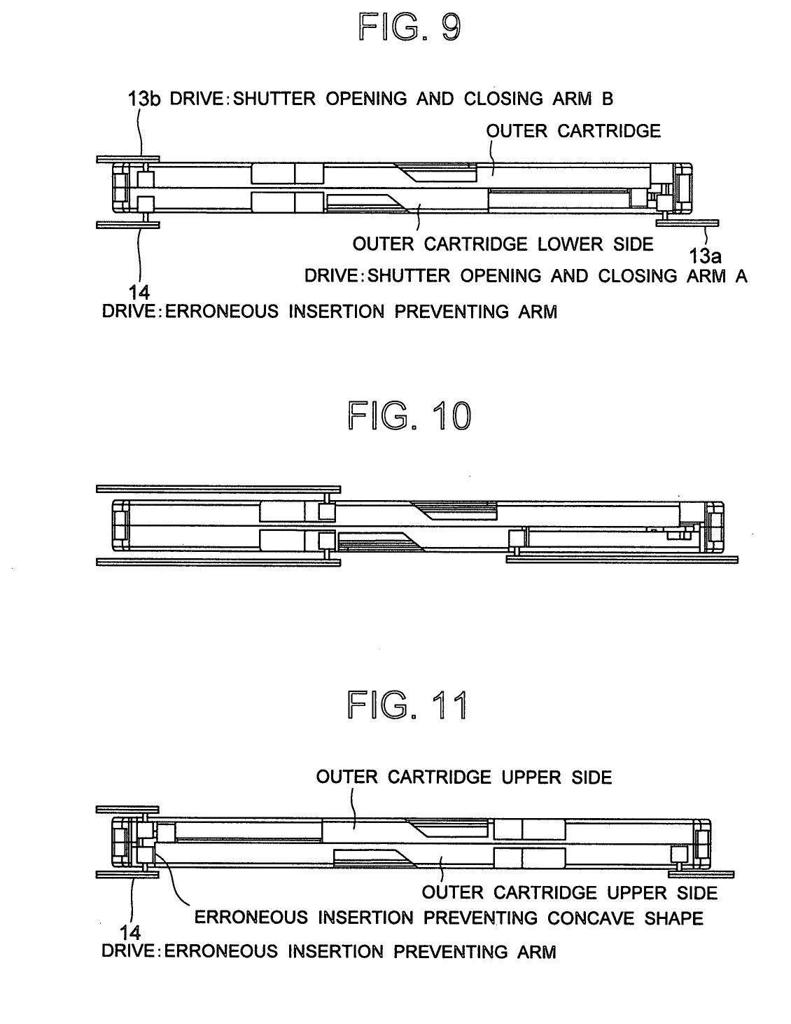

A shutter opening and closing arm 13 and an erroneous insertion preventing arm 14 are provided in the drive (not shown) recording and reproducing the disc cartridge in accordance with the embodiment of the present invention (refer to FIGS. 9 to 11). The shutter opening and closing arm 13 is provided at a position of being brought into contact with the slider 2 incorporated in the cartridge case 1 for opening and closing the shutter 4, and there is provided an arm runout concave shape into which another shutter opening and closing arm 13 and erroneous insertion preventing arm 14 which do not execute the shutter opening motion enter. Further, the cartridge case 1 having a one-side specification is provided with a concave inverse direction insertion preventing stopper on which the erroneous insertion preventing arm 14 catches at a time of inserting in an inverse direction.

In this case, as a matter of convenience, the shutter opening and closing arm 13 provided in a right lower side with respect to a forward inserting direction of the cartridge case 1 is called as an opening and closing arm A 13a, and the shutter opening and closing arm 13 provided in a left upper side is called as an opening and closing arm B 13b.

FIG. 9 shows a shutter closed state of the cartridge case having the one-side specification. When the cartridge case having the one-side specification is inserted, the opening and closing arm A 13a actuates so as to open the shutter 4 in the insertion in the forward direction, and the opening and closing arm B 13b and the inverse insertion preventing arm 14 slip on the surface in the drive inserting direction of the cartridge case 1 and enter into the arm runout concave shape near the full opening time of the shutter 4, whereby the shutter 4 is fully opened. At a time of the insertion in the inverse direction, the erroneous insertion preventing arm 14 catches on the erroneous insertion preventing stopper and can not be inserted any more, as shown in FIG. 11.

When the cartridge case 1 having both-side specification is inserted, the opening and closing arm A 13a actuates so as to open the shutter 4 in the same manner as the insertion of the cartridge case having the one-side specification at a tie of the insertion in the forward direction, and the opening and closing arm B 13b and the erroneous insertion preventing arm 14 slip on the surface in the drive inserting direction of the cartridge case 1, and enter into the arm runout concave shape near the full opening time of the shutter 4, whereby the shutter 4 is fully opened. In the insertion in the inverse direction, the opening and closing arm B 13b actuates so as to open the shutter 4, and the opening and closing arm A 13a and the erroneous insertion preventing arm 14 slip on the surface in the drive inserting direction of the cartridge case 1, and enter into the arm runout concave shape near the full opening time of the shutter 4, whereby the shutter 4 is fully opened.

### <About Material of Each of Members>

As a material used for the cartridge case, a polycarbonate (PC) resin or an acrylonitrile butadiene styrene (ABS) resin is desirable by taking a strength and a formability into consideration. In order to achieve the light shielding effect, the material is colored in black by mixing a pigment, a dye, a carbon or the like, colored in dark color such as blue, brown or the like by the pigment or the dye, or colored in red corresponding to a safety light of the present hologram media by the pigment or the dye. Alternatively, there is used the resin mixed with a metallic additive agent having a light reflecting effect such as an aluminum filler or the like. Alternatively, it is desirable that the front surface and the back surface are coated in black by a lacquer paint, a water paint or an enamel paint, or coated in dark color such as blue, brown or the like, or coated in red corresponding to the safety light of the present hologram media.

Further, it is desirable that the slider uses a polyacetal (POM) resin corresponding to a different material from the material of the cartridge case for sliding within the cartridge case while being fitted to the cartridge case, and it is desirable that the slider is colored in black in the same manner while taking the light shielding effect into consideration, colored in dark color such as blue, brown or the like, or colored in red corresponding to the safety light of the present hologram media. Alternatively, it is desirable that the front surface is coated in black by the lacquer paint, the water paint or the enamel paint, or coated in dark color such as blue, brown or the like, or coated in red corresponding to the safety light of the present hologram media.

Further, since a hinge characteristic is required in the lock member, it is desirable to use the polyacetal (POM) resin.

Further, taking the strength and the formability into consideration, the shutter can use the resin material such as the polycarbonate (PC) resin, the acrylonitrile butadiene styrene (ABS) resin or the polyacetal (POM) resin, however, since the shutter slides within the cartridge required to be thinned, it is desirable to use a stainless steel (SUS) material or an aluminum alloy material in which it is easy to be thinned and the light shielding effect tends to be maintained even if the thickness is thin.

In the case of using the resin material for the shutter, in order to achieve the light shielding effect, the shutter is colored in black by mixing the pigment, the dye or the carbon, or colored in dark color such as blue, brown or the like by the pigment or the dye, or colored in red corresponding to the safety color of the present hologram media by the pigment or the dye. Alternatively, there is used the resin mixed with the metallic additive agent having the light reflecting effect such as the aluminum filler or the like. Alternatively, it is desirable that the front surface and the back surface are coated in black by the lacquer paint, the water paint or the enamel paint, or coated in dark color such as blue, brown or the like, or coated in red corresponding to the safety light of the present hologram media.

In the case that the metal material is used in the shutter, the shutter may be uncoated as it is, however, in order to further achieve the light shielding effect, it is desirable that the back surface is colored in black by the pigment, the dye or the like, or colored in dark color such as blue, brown or the like by the pigment or the dye, or colored in red corresponding to the safety light of the present hologram media by the pigment or the dye.

### <Summary>

As mentioned above, in accordance with the embodiment of the present invention, there is provided the disc cartridge having the double structure and used in the hologram information recording and reproducing apparatus in which the tracking area detecting head and the recording and reproducing head are independently provided. In other words, the disc cartridge in accordance with the present embodiment is provided with the outer cartridge, the inner cartridge accommodated in the inner side of the outer cartridge and rotatably accommodating the hologram recording medium in the inner portion, and the shutter arranged between the outer cartridge and the inner cartridge for opening and closing the opening portion of the disc cartridge. Further, the opening portion includes the spindle insertion hole and the tracking area detecting window provided independently from the spindle insertion hole. Further, the tracking area detecting window is provided near the center of the cartridge of the spindle insertion hole, and comes to the exposed state only at a time when the shutter is open. Preferably, the tracking area detecting window is provided so as to have an angle between 40 and 50 degree from the center line of the spindle insertion hole. In accordance with this structure, it is possible to minimize an area of the opening portion of the shutter (and an area of the shutter) even in the two-head system. Further, two heads are not interfered even in the two-head system, it is possible to record and reproduce the information to the limit of the innermost circumference of the recording region, and it is possible to achieve the disc cartridge which is excellent in the light shielding effect and the dust proofing effect.

In this case, in the case of the present invention, the tracking pattern is provided in the innermost circumference of the hologram recording medium. Accordingly, the tracking area detecting window is provided near the spindle insertion hole of the cartridge. Further, it is desirable that the tracking area detecting window is provided in the surface with which the spindle of the disc drive is brought into contact, in the disc cartridge, and is formed in the larger circle than the diameter of the laser beam for the tracking servo. As mentioned above, since the tracking area detecting window is provided independently from the spindle insertion hole and very small, the tracking area detecting window is effective for increasing the light shielding effect of the cartridge.

Further, as mentioned above, since the head for the tracking servo and the recording and reproducing head are not interfered, there is obtained an effect that the freedom of designing the recording and reproducing head (drive) is increased.

The tracking area detecting window is provided near the spindle insertion hole in the sliding direction side of the shutter, and the shutter is provided with the notch in the edge portion in the opposite side to the sliding direction side. On the basis of the notch, the tracking area detecting window comes to the exposed state at a time when the shutter is fully open. In other words, if the notch is not provided, the tracking detecting window does not completely come to the exposed state. It is possible to effectively make good use of the edge portion of the spindle insertion hole provided in the cartridge, by employing the structure mentioned above.

1. A disc cartridge used in a hologram information recording and reproducing apparatus independently provided with a head for detecting a tracking area and a head for recording and reproducing, the disc cartridge comprising:
an outer cartridge;
an inner cartridge accommodated in an inner side of said outer cartridge and rotatably accommodating a hologram recording medium in an inner portion thereof; and
a shutter arranged between said outer cartridge and said inner cartridge and provided for opening and closing an opening portion of the disc cartridge,
wherein said opening portion includes a recording and reproducing head and spindle insertion hole, and a tracking area detecting window provided independently therefrom, and
wherein said tracking area detecting window is provided near a center of the cartridge, and comes to an exposed state only at a time when said shutter is open.

2. A disc cartridge as claimed in claim 1, wherein said tracking area detecting window is provided at an angle between 40 to 50 degree from a center line of said recording and reproducing head and spindle insertion hole.

3. A disc cartridge as claimed in claim 1, wherein said tracking area detecting window is provided in a surface with which the spindle of the disc drive is brought into contact, in said disc cartridge.

4. A disc cartridge as claimed in claim 2, wherein said tracking area detecting window is provided in a surface with which the spindle of the disc drive is brought into contact, in said disc cartridge.

5. A disc cartridge as claimed in claim 1, wherein said tracking area detecting window is formed in a larger circular shape than a diameter of the laser beam for the tracking servo.

6. A disc cartridge as claimed in claim 2, wherein said tracking area detecting window is formed in a larger circular shape than a diameter of the laser beam for the tracking servo.

7. A disc cartridge as claimed in claim 3, wherein said tracking area detecting window is formed in a larger circular shape than a diameter of the laser beam for the tracking servo.

8. A disc cartridge as claimed in claim 4, wherein said tracking area detecting window is formed in a larger circular shape than a diameter of the laser beam for the tracking servo.

9. A disc cartridge as claimed in claim 1, wherein said tracking area detecting window is provided near said spindle insertion hole in a sliding direction side of said shutter,
wherein said shutter is provided with a notch in an edge portion in an opposite side to the sliding direction side, and
wherein on the basis of the notch, said tracking area detecting window comes to the exposed state at a time when said shutter is fully open.

10. A disc cartridge as claimed in claim 2, wherein said tracking area detecting window is provided near said spindle insertion hole in a sliding direction side of said shutter,
wherein said shutter is provided with a notch in an edge portion in an opposite side to the sliding direction side, and
wherein on the basis of the notch, said tracking area detecting window comes to the exposed state at a time when said shutter is fully open.

11. A disc cartridge as claimed in claim 3, wherein said tracking area detecting window is provided near said spindle insertion hole in a sliding direction side of said shutter,
wherein said shutter is provided with a notch in an edge portion in an opposite side to the sliding direction side, and
wherein on the basis of the notch, said tracking area detecting window comes to the exposed state at a time when said shutter is fully open.

12. A disc cartridge as claimed in claim 4, wherein said tracking area detecting window is provided near said spindle insertion hole in a sliding direction side of said shutter,
wherein said shutter is provided with a notch in an edge portion in an opposite side to the sliding direction side, and
wherein on the basis of the notch, said tracking area detecting window comes to the exposed state at a time when said shutter is fully open.

13. A disc cartridge as claimed in claim 5, wherein said tracking area detecting window is provided near said spindle insertion hole in a sliding direction side of said shutter,
wherein said shutter is provided with a notch in an edge portion in an opposite side to the sliding direction side, and
wherein on the basis of the notch, said tracking area detecting window comes to the exposed state at a time when said shutter is fully open.

14. A disc cartridge as claimed in claim 6, wherein said tracking area detecting window is provided near said spindle insertion hole in a sliding direction side of said shutter,
wherein said shutter is provided with a notch in an edge portion in an opposite side to the sliding direction side, and
wherein on the basis of the notch, said tracking area detecting window comes to the exposed state at a time when said shutter is fully open.

15. A disc cartridge as claimed in claim 7, wherein said tracking area detecting window is provided near said spindle insertion hole in a sliding direction side of said shutter,
wherein said shutter is provided with a notch in an edge portion in an opposite side to the sliding direction side, and
wherein on the basis of the notch, said tracking area detecting window comes to the exposed state at a time when said shutter is fully open.

16. A disc cartridge as claimed in claim 8, wherein said tracking area detecting window is provided near said spindle insertion hole in a sliding direction side of said shutter,
wherein said shutter is provided with a notch in an edge portion in an opposite side to the sliding direction side, and
wherein on the basis of the notch, said tracking area detecting window comes to the exposed state at a time when said shutter is fully open.
